(19) United States
(12) Patent Application Publication
(10) Pub. No.: US 2013/0039634 A1
(43) Pub. Date: Feb. 14, 2013

(54) SYSTEM AND METHOD OF CREATING AN INTELLIGENT VIDEO CLIP FOR IMPROVED INVESTIGATIONS IN VIDEO SURVEILLANCE

(71) Applicant: Deepak Sundar M, Bangalore (IN)

(72) Inventor: Deepak Sundar M, Bangalore (IN)

(73) Assignee: Honeywell International Inc., Morristown, NJ (US)

(21) Appl. No.: 13/209,078

(22) Filed: Aug. 12, 2011

(51) Int. Cl. H04N 5/775

(52) U.S. Cl. 386/230; 386/E05.07

(57) ABSTRACT

Systems and methods to create, display, and play self-explanatory video data streams for use in video surveillance are provided. Methods include displaying and playing an incident video data stream in a primary video panel on a viewing screen, and displaying and playing at least one playback session of the incident video data stream in at least one secondary video panel on the viewing screen. The at least one playback session corresponds to at least one marked key moment in the incident video data stream, and the at least one playback session is played in the at least one secondary video panel at a time corresponding to when the at least one marked key moment in the incident video data stream is being playing in the primary video panel.

### FIELD OF INVENTION

The present invention relates generally to video surveillance. More particularly, the present invention relates to systems and methods for creating, displaying, and playing video clips for improved investigations and incident management in video surveillance and where ever video data streams are used for evidentiary purposes.

### BACKGROUND

Video surveillance systems are integral to many security systems. For example, many video surveillance systems include surveillance cameras, video recorders (DVR, NVR, etc), controllers, and viewers. In operation, a video surveillance system can generate an alarm when a certain event occurs or when an operator manually bookmarks the video data stream. For example, while conducting real time monitoring, an operator can bookmark a video data stream when he detects a certain activity that warrants future review.

When reviewing a recorded video data stream, an operator can select a portion of the video data stream for further review, and possibly forensic review. For example, the video data stream can be used for an evidentiary purpose, such as showing the video data stream to a third party agency or a court of law. The operator can also export the selected portion of the video data stream.

When a portion of a video data stream is exported, often the video data stream will not be self explanatory. Therefore, operators must often add some type of voice annotation to the video data stream or manually explain the video data stream to a third party, for example, the operator's supervisor, while the data stream is playing.

There is currently no known mechanism to otherwise identify key moments in an exported video data stream. Thus, investigators and operators must spend extra, and often wasted, time trying to understand what they are viewing in an exported video data stream. For example, when an operator reaches a key moment in an exported video data stream, he must often pause, reverse, and re-play the key moment several times in order to clearly understand the incident.

There is thus a continuing, ongoing need for systems and methods to create, display, and play self-explanatory video data streams for use in video surveillance.

### BRIEF DESCRIPTION OF THE DRAWINGS

FIG. 1 is a flow diagram of a method of exporting a video data stream in accordance with the present invention;

FIG. 2 is a flow diagram of a method of using a video data stream for video surveillance in accordance with the present invention;

FIG. 3 is a block diagram of a system for carrying out the methods of FIG. 1 and FIG. 2 in accordance with the present invention;

FIG. 4 is an interactive window displayed on a viewing screen of a graphical user interface for monitoring and reviewing video data streams in accordance with the present invention;

FIG. 5 is an interactive window displayed on a viewing screen of a graphical user interface for selecting a portion of a video data stream as an incident portion in accordance with the present invention;

FIG. 6 is an interactive window displayed on a viewing screen of a graphical user interface for adding and selecting key moments in an incident video data stream in accordance with the present invention; and

FIG. 7 is an interactive window displayed on a viewing screen of a graphical user interface for exporting, displaying, and playing an incident video data stream for further review.

### DESCRIPTION OF THE PREFERRED EMBODIMENTS

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments of the present invention include systems and methods to create, display, and play self-explanatory video data streams for use in video surveillance and for explaining video data streams to a third party, for example, for an evidentiary purpose. Preferably, such systems and methods can play the video data stream as well as multiple playback sessions of the video data stream that correspond to marked key moments.

In accordance with the present invention, viewers of an exported video data stream can understand, within a short period of time, incidents occurring in the video data stream, even if the length of the video data stream is much longer.

For example, in accordance with the present invention, each marked key moment of an incident can be treated as one playback session of the video data stream. Each marked key moment can explain the flow or sequence of the incident within the incident video data stream.

In embodiments of the present invention, only one video data stream is exported with at least one key moment marked therein, for example, a key frame of the video data stream that is marked. While playing the single video data stream, playback sessions of the video data stream can also begin with different starting times, depending upon the marked key frames.

A key moment can be considered a key frame and are used interchangeably herein. For example, a key moment can be the time that an operator wants to mark on timeline corresponding to a video data stream when creating an exporting a video clip. Similarly, a key frame is the frame within a video data stream or exported video clip corresponding to the marked key moment.

In accordance with the present invention, an operator can create an incident video data stream by selecting a portion of a video data stream that corresponds to an incident, for example, an alarm, an event, a suspicious activity, or a manual bookmark created by an operator during real time surveillance. Then, the operator can select key moments in the incident video data stream before exporting the video data stream. For example, the operator can select key moments by marking the moments on a corresponding time line.

Key moments in the incident video data stream can be any moment as would be desired by one of ordinary skill in the art. For example, key moments can include the following: an intruder entering a room in a particular frame or at a particular time in the video data stream; a theft occurring or an object missing in a particular frame of the video data stream; an intruder attacking a shopkeeper in a particular frame of the video data stream; an intruder or suspect beginning to run or leave a monitored area in a particular frame of the video data stream; and an intruder's face being visible in a particular frame of the video data stream. Thus, a key moment can include any alarm, event, or suspicious activity that is detected by an operator or system in accordance with the present invention, for example, any video analytic alarms/events, such as restricted zone entry, loitering in a restricted area, a person or vehicle moving in the wrong direction, a person on a fence line, a person starting/stopping running, trespassing or tripwire detection, an object left unattended, an object removed, etc.

Alarms and events need not only be from closed circuit television (CCTV) or video surveillance systems. Rather, alarms and events could be detected and signaled from any integrated system, such as an access control system, intrusion detection system, life safety system (e.g., fire, gas detection and evacuation systems), building management system, process automations system, or any monitoring system or alarm management system as would be known by those of skill in the art.

When an incident video data stream is displayed and/or played, the entirety of incident video data stream can be played while the key moment playback sessions of the incident video data stream are also played. For example, the number of playback sessions in the incident video data stream can correspond to the number of key moments that were marked, bookmarked, or selected by the operator. The key moment playback sessions can be played according to the time that the respective key moment is marked on a time line corresponding to the incident video data stream.

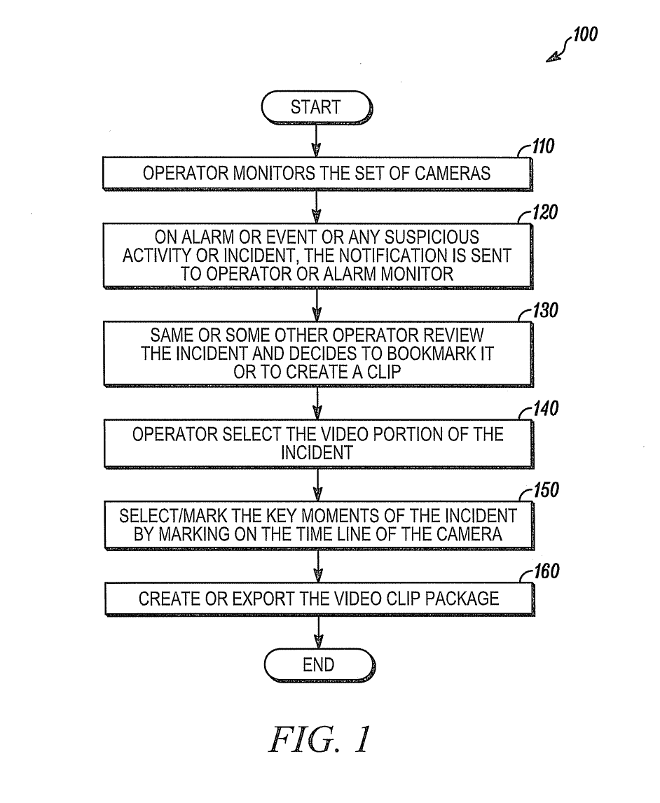

FIG. 1 is a flow diagram of a method 100 of exporting a video data stream in accordance with the present invention. As seen in FIG. 1, an operator can monitor video data streams from a set of cameras as in 110. When an alarm, event, or any other suspicious activity or unexpected incident occurs, a notification can be sent to the operator or other alarm monitor as in 120. In some embodiments, the incident can be detected by the operator and/or by systems in accordance with the present invention.

The operator can review the incident as in 130 and, based on that review, bookmark the incident or create an incident video data stream as in 130. To create an incident video data stream, the operator can select a portion of the video data stream corresponding to the incident as in 140. Then, the operator can select and/or mark key moments of the incident in the incident video data stream as in 150. For example, the operator can mark the key moments as bookmarks on a timeline of the incident video data stream.

Finally, the incident video data stream can be created, stored, and exported as in 160. In some embodiments, the incident video data stream can be stored on an internal storage medium, such as a local hard disc. In some embodiments, the incident video data stream can be stored on an external storage medium, such as a CD, USB storage device, SD card, cloud storage, network storage, etc. In either embodiment, the stored incident video data stream can be accessed by authorized personnel, for example, system administrators and operators, forensic operators, and investigators.

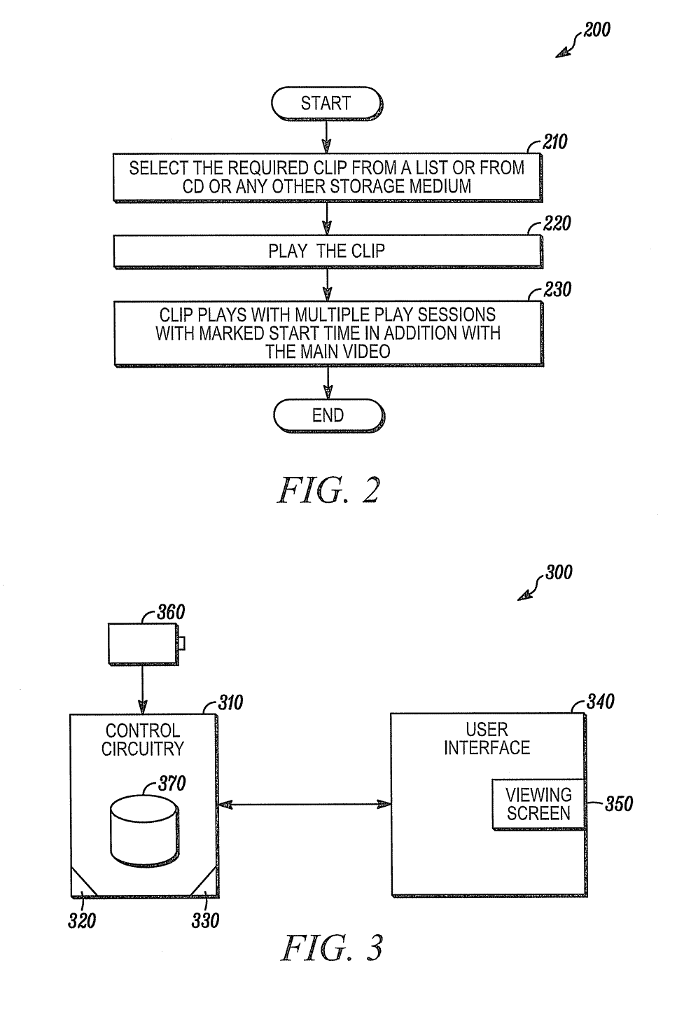

FIG. 2 is a flow diagram of a method 200 of using a video data stream for video surveillance in accordance with the present invention. As seen in FIG. 2, an operator can select an incident video data stream as in 210. For example, the operator can select the incident video data stream from a list, a CD, an internal or external storage medium, or any other non-transitory storage medium as would be known by those of skill in the art. Then, the selected incident video data stream can be played as in 220. While the incident video data stream is playing, the entirety of incident video data stream can be played and the multiple playback sessions can be played as in 230. In some embodiments, an operator can play only the entire incident video data stream, only the playback sessions, or both in combination, as needed. The multiple playback sessions can correspond to the marked start times of the key moments in the incident video data stream.

The methods shown in FIG. 1, FIG. 2, and others in accordance with the present invention can be implemented with a plurality of video cameras 360 in communication with the system 300 shown in FIG. 3. As seen in FIG. 3, the system 300 can include control circuitry 310, one or more programmable processors 320, and executable control software 330 as would be understood by those of skill in the art. The executable control software can be stored on a transitory or non-transitory local computer readable medium.

An associated user interface 340 can be in communication with the control circuitry 310, and a viewing screen 350 of the user interface 340, as would be known by those of skill in the art, can display interactive and viewing windows. In some embodiments of the present invention, the user interface 340 can be a multi-dimensional graphical user interface.

Video data streams from the plurality of video cameras 360 can be reviewed in real time and/or be stored by a database 370 for later review. Then, an operator can view the video data streams via the viewing screen 350 of the user interface 340. After the creation of an incident video data stream, an operator can also review the incident video data streams, as well as playback sessions corresponding to marked key moments in the incident video data stream, via the viewing screen 350 of the user interface 340. In some embodiments, an operator can make changes to the incident video data stream by, for exampling, adding, deleting or modifying the key moment markings, before exporting the final video clip.

The interactive and viewing windows shown and described herein are exemplary only. Those of skill in the art will understand that the features of the windows shown and described herein may be displayed by additional or alternate windows. Additionally, the windows shown and described herein can be displayed on any type of user device, for example, personal digital assistants, smart phones, and/or handheld devices.

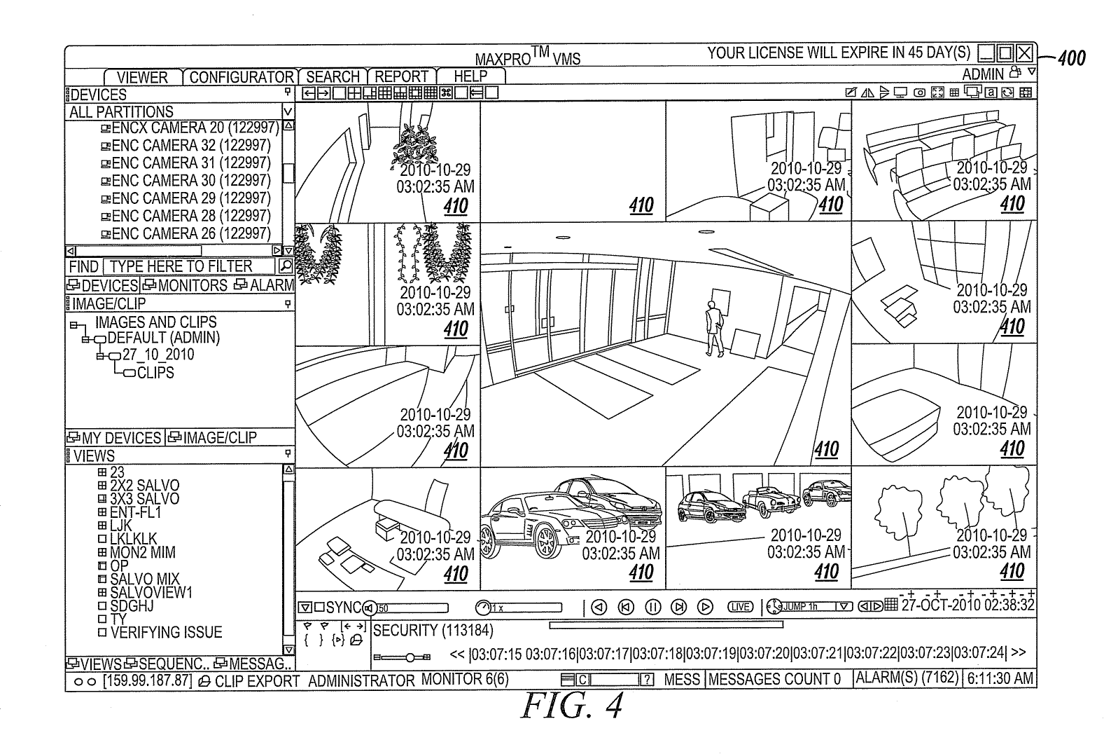

FIG. 4 is an interactive window 400 displayed on a viewing screen of a graphical user interface for monitoring and reviewing video data streams in accordance with the present invention. As seen in FIG. 4, the window 400 can display video data streams from a plurality of different cameras monitoring a surveillance area.

For example, the window 400 can include a plurality of video panels 410, each of which displays and plays a video data stream from a respective surveillance camera monitoring a respective surveillance area. When viewing the window 400, an operator can monitor a video panel 410, and accordingly each respective camera and each respective surveillance area, substantially simultaneously.

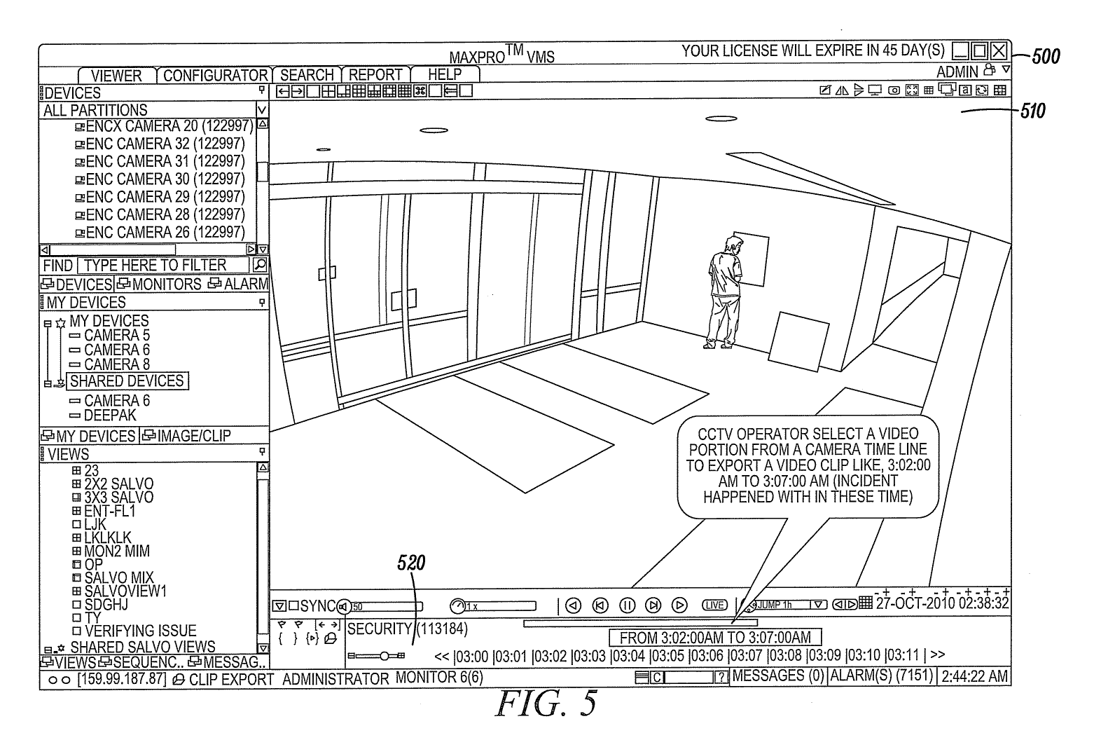

FIG. 5 is an interactive window 500 displayed on a viewing screen of a graphical user interface for selecting a portion of a video data stream as an incident portion in accordance with the present invention. As seen in FIG. 5, the window 500 can include a maximized video panel 510 that displays a particular video data stream from a particular camera monitoring a particular surveillance area. The window 500 can also include timeline panel 520 that displays a timeline of the particular video data stream.

When an incident is detected in the particular video data stream, an operator can select a portion of the particular video data stream. For example, an operator can select a period of time on the timeline corresponding to the particular video data stream. The period of time can correspond to the period of time in which the operator believes the incident occurred. Furthermore, the portion of the particular video data stream selected by the operator can be considered the incident video data stream.

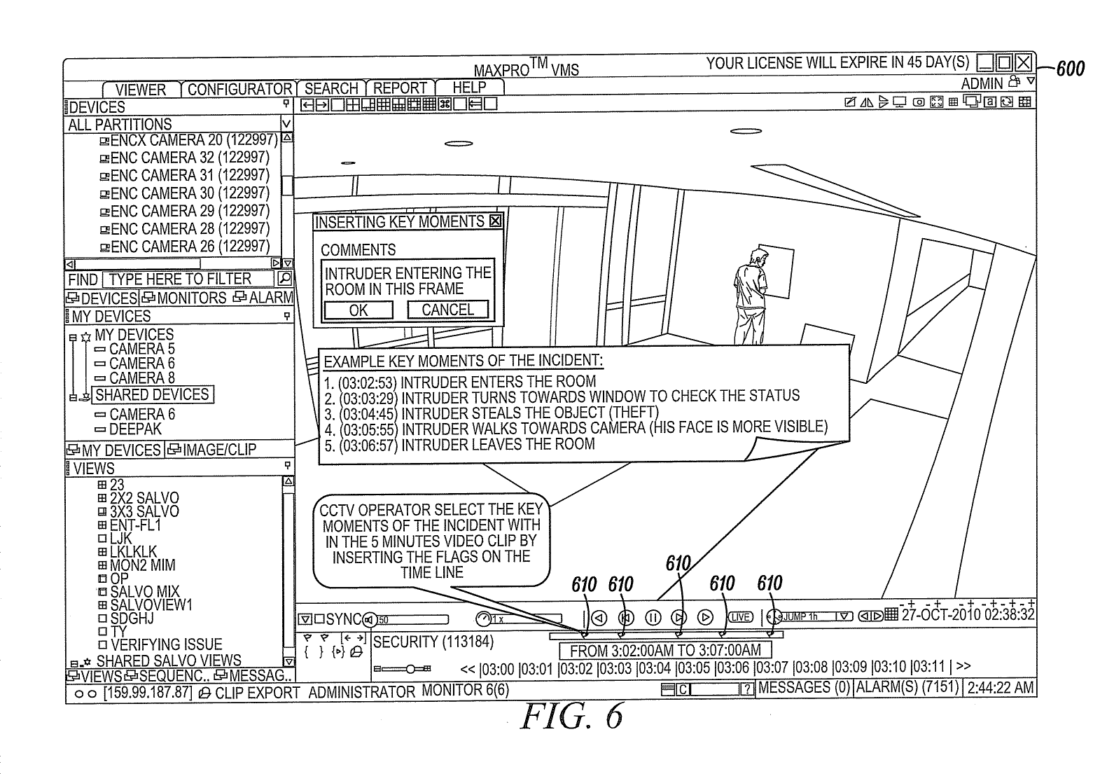

FIG. 6 is an interactive window 600 displayed on a viewing screen of a graphical user interface for adding and selecting key moments in an incident video data stream in accordance with the present invention. As seen in FIG. 6, an operator can select key moments in an incident video data stream by, for example, inserting flags or bookmarks 610 on the timeline corresponding to the incident video data stream. In some embodiments, key moments can correspond to alarms or events identified by systems in accordance with the present invention.

The operator can also enter comments in a separate window to explain the incident video data stream at a particular key moment. For example, the comments can correspond to a particular flag 610 and explain to a user what is occurring at that time. The comments can also include a title for a sub-window to display a video data stream corresponding with a respective key moment.

In some embodiments of the present invention, a video data stream corresponding to a key moment can be zoomed, for example, digitally zoomed, to highlight a region of interest. The amount of zoom can be determined and saved while marking the key moment and can be reset as needed.

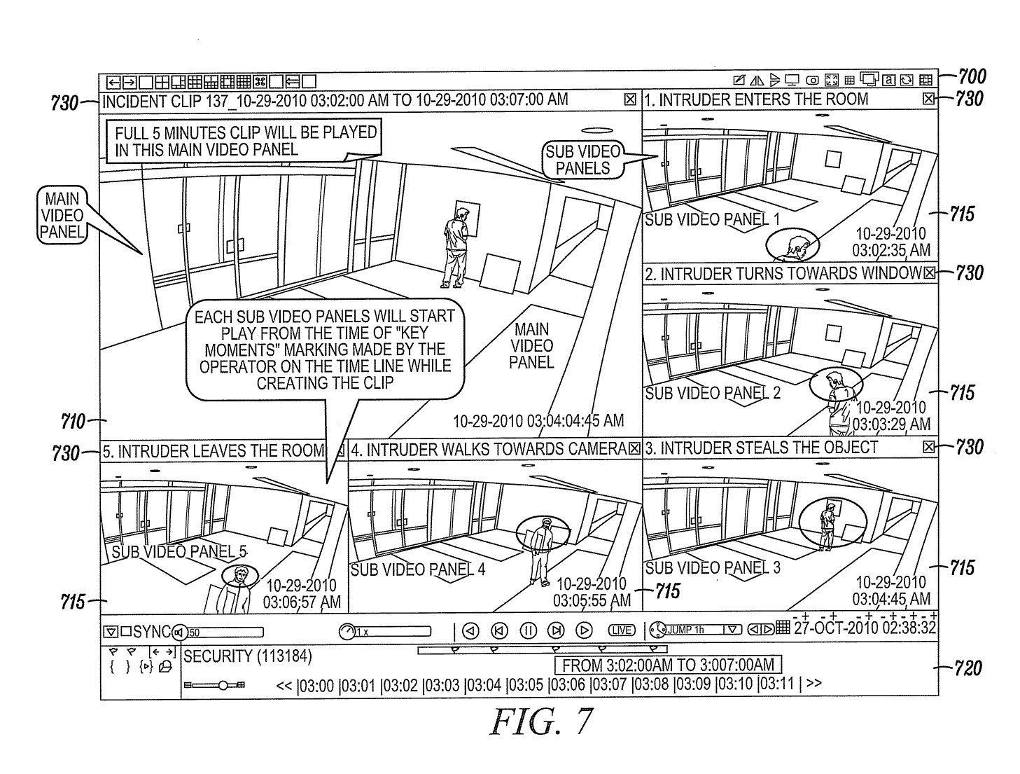

FIG. 7 is an interactive window 700 displayed on a viewing screen of a graphical user interface for exporting an incident video data stream for further review. As seen in FIG. 7, the window 700 can include a primary video panel 710, a plurality of secondary video panels 715, and timeline panel 720. In some embodiments, each of the video panels can be titled with comments that were previously entered by an operator. Furthermore, each of the sequential numbers can be titled with sequential numbers.

As seen in FIG. 7, while playing the exported incident video data stream, each of the secondary video panels can show the key moment time and the current playing time. For example, the key moment time and the current playing time can be superimposed over an image of the playback session.

The incident video data stream can be exported as a package. For example, the package can contain the entire incident video data stream as well as the marked key moments therein. In embodiments of the present invention, only one full length video clip—the incident video data stream—will be exported. When the incident video data stream is played, systems and methods in accordance with the present invention can identify the marked key moments as well as the time of those moments in the incident video data stream. Then, based on this information, a plurality of secondary video panels can play and display playback sessions corresponding to the marked key moments.

It is to be understood that in accordance with the present invention, only one video clip is exported. For example, assume a video clip, that is, an incident video data stream, is five minutes in length (01.01.00 am to 01.05.00 am) and that an operator has marked three key moments within the incident video data stream. The key moments can be marked at times 01.01.30 am, 01.02.30 am and 01.03.30 am, respectively. When the incident video data stream is exported, only one video clip having a five minute duration (01.01.00 am to 01.05.00 am) is exported. However, the exported video clip includes marked frames therein that correspond to the marked key moments.

In some embodiments of the present invention, when an incident video data stream is being played for the first time, systems and methods of the present invention will only load images of the key moment frames in the primary and secondary video panels. Then, the incident video data stream can be played as needed.

In other embodiments of the present invention, whenever an incident video data stream is exported, each of the primary and secondary video panels can load only images of the marked key moments and frames. This allows a user to obtain an overview of the incident video data stream and evaluate basic information about the incident captured therein. Then, a user can determine whether to play the incident video data stream or not. For example, if the user can obtain enough information from just the images, he need not play the clip. However, if the user needs more information, he can play the video data stream.

The primary video panel 710 can display the entirety of the incident video data stream. For example, the primary video panel can play the entire incident video data stream, from start to the finish. In some embodiments, the primary video panel 710 can also display and play marked key moments and frames as needed. A plurality of secondary video panels 715 can display and play a playback session of the incident video data stream. That is, each of the plurality of secondary video panels 715 can display and play a portion of the incident video data stream corresponding to a respective key moment. For example, each of the plurality of secondary video panels 715 can play the incident video data stream from the start of a respective key moment to the end of the respective key moment. In some embodiments, a first key moment time displayed and played in a first secondary video panel 715 can be the same as the entire incident video clip displayed and played in the primary video panel 710.

Each video panel 710, 715 can include a title bar 730 relative to the video panel 710, 715 that displays a title for the video panel 710, 715. When a secondary video panel 715 is playing a video data stream of a key moment, the title bar 730 of that secondary video panel 715 and/or the title bar 730 of the primary video panel 710 can flash and/or blink. For example, the title bar 730 of the primary video panel 710 can flash and/or blink with the title of the secondary video panel 715 playing the video data stream of the key moment. In some embodiments, a particular key moment flag on the associated timeline also can flash and/or blink when the incident video data stream reaches a time associated with that particular key moment flag.

According to some embodiments of the present invention, a video data stream corresponding to a key moment, that is, a playback session of the incident video data stream can be played in a loop or for a predetermined period of time. For example, video data stream corresponding to a playback session can be displayed in a secondary video panel 715 during the key moment and then be continuously and repeatedly displayed in the secondary video panel 715 for the predetermined period of time after the end of the key moment.

In some embodiments of the present invention, the primary video panel 710 can display a video data stream corresponding to a key moment. For example, an operator can select to view a key moment in the primary video panel 710 so as to obtain a larger view of the displayed video data stream. In other embodiments, video data streams being displayed in any of the video panels 710, 715 can be displayed in on a full screen of the window 700.

In embodiments of the present invention, an operator can select the number of video panels 710, 715 to be used for displaying the incident video data stream. For example, the operator can select a number of video panels 710, 715 that corresponds to the number of key moments in the incident video data stream. In some embodiments, the number of video panels can be decided at the time of exporting a video clip and can be altered both before and after the clip export.

In some embodiments, the operator can choose a first plurality of key moments to be displayed in a first window with a first set of video panels and a second plurality of key moments to be displayed in a second window with set of video panels. For example, if an incident video data stream includes six key moments, a first window can include four video panels and a second window can include four video panels. In the first window, one of the four video panels can be the primary video panel and each of the three other video panels can be secondary video panels. In the second window, one of the four video panels can be the primary video panel and each of the three other video panels can be secondary video panels. In embodiments of the present invention, an operator can alternate between viewing the first and second window. For example, each of the first and second windows can display “Previous” or “Next” icons to switch between the first and second windows. Or same viewing window will have next and previous buttons to view the first and the second set of videos.

When an operator manipulates the incident video data stream, all of the video panels 710, 715 can react accordingly and substantially simultaneously. For example, if an operator selects to play, reverse, pause, stop, step reverse, step forward, time jump, or the like, the video data streams being displayed in each video panel 710, 715 can react accordingly.

In accordance with the present invention, when an incident video data stream is selected and/or loading for display and/or viewing, the entire incident video data stream can be loaded. That is, the incident video data stream and each of the key moments marked therein are loaded substantially simultaneously.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

From the foregoing, it will be observed that numerous variations and modifications may be effected without departing from the spirit and scope of the invention. It is to be understood that no limitation with respect to the specific system or method illustrated herein is intended or should be inferred. It is, of course, intended to cover by the appended claims all such modifications as fall within the spirit and scope of the claims.

What is claimed is:

1. A method comprising:
displaying a video data stream;
creating an incident video data stream, the incident video data stream being a portion of the video data stream corresponding to an incident occurring;
marking at least one key moment in the incident video data stream; and
exporting only the incident video data stream, the incident video data stream including the at least one key moment marked therein.

2. The method of claim 1 wherein the incident includes an alarm, event, suspicious activity, or manual bookmark created by an operator during real time surveillance.

3. The method of claim 1 wherein the at least one key moment includes at least one of a period of time or video frame in which an alarm, event, or suspicious activity is detected or in which a video analytic alarm or event is detected and signaled by an integrated system.

4. The method of claim 1 wherein the least one key moment includes at least one of a period of time or video frame in which an intruder enters a monitored area, a theft occurs in the monitored area, an object in the monitored area is missing, an attack in the monitored area occurs, an intruder in the monitored area begins fleeing, an intruder's face is visible to a surveillance camera, an alarm, event, or suspicious activity is detected, or in which a video analytic alarm or event is detected and signaled by an integrated system, the video analytic alarm or event including at least one of restricted zone entry, loitering in restricted area, a person or vehicle moving in wrong direction, a person on fence line, a person started/stopped running, trespassing or tripwire detection, an object left unattended, or an object removed, the integrated system being at least one of a CCTV system, a video surveillance system, and access control system, an intrusion detection system, a life safety system, a building management system, a process automations/solutions system, a monitoring system, or an alarm management system.

5. The method of claim 1 wherein marking the at least one key moment in the incident video data stream includes marking the at least one key moment on a timeline corresponding to the incident video data stream.

6. The method of claim 1 wherein marking the at least one key moment in the incident video data stream includes associating comments with the at least one key moment.

7. The method of claim 1 wherein exporting the incident video data stream includes exporting only one incident video data stream with the at least one key moment marked therein.

8. The method of claim 1 wherein the displaying, creating, marking, and exporting is executed with a video or media player or with at least one of a personal computer, CCTV workstation, thin client, thick client, personal digital assistant, smart phone, or handheld device, and wherein any of the personal computer, CCTV work station, thin client, thick client, personal digital assistant, smart phone, or handheld device includes internet, cloud, or web-based hardware.

9. A method comprising:
displaying and playing an incident video data stream in a primary video panel on a viewing screen; and
displaying and playing at least one playback session in at least one secondary video panel on the viewing screen,
wherein the at least one playback session corresponds to at least one marked key moment in the incident video data stream, and
wherein the at least one playback session is played in the at least one secondary video panel at a time corresponding to when the at least one marked key moment in the incident video data stream is being playing in the primary video panel.

10. The method of claim 9 further comprising displaying and playing a plurality of playback sessions in a plurality of secondary video panels on the viewing screen, wherein each of the plurality of playback sessions corresponds to a respective marked key moment in the incident video data stream.

11. The method of claim 10 wherein a number of secondary video panels on the viewing screen can correspond to a number of marked key moments in the incident video data stream.

12. The method of claim 10 wherein each of the plurality of playback sessions is played in a respective one of the plurality of secondary video panels on the viewing screen at a time corresponding to when the respective one of the marked key moments is being played in the primary video panel.

13. The method of claim 10 further comprising playing the incident video data stream in the primary video panel and playing the plurality of playback sessions in the secondary video panels at a plurality of different start times.

14. The method of claim 9 further comprising displaying a timeline of the incident video data stream, including the at least one marked key moment, in a timeline panel of the viewing screen.

15. The method of claim 9 further comprising displaying a title bar for each of the primary video panel and the at least one secondary video panel,
wherein the title bar includes a title for the incident video data stream or the at least one playback session, and
wherein the title corresponds to comments entered by a user.

16. The method of claim 15 further comprising:
flashing the title bar for the at least one secondary video panel when the at least one playback session is being played in the at least one secondary video panel,
wherein the at least one playback session is being played in the at least one secondary video panel when the incident video data stream reaches the time when the at least one marked key moment in the incident video data stream is being playing in the primary video panel.

17. The method of claim 14 further comprising:
flashing the title bar for the primary video panel with a title of the at least one secondary video panel when the at least one playback session is being played in the at least one secondary video panel.

18. The method of claim 9 further comprising playing the at least one playback session in the at least one secondary video panel in a loop for a predetermine period of time after the at least one marked key moment in the incident video data stream.

19. The method of claim 9 further comprising the playing of the incident video data stream in the primary window and the playing of the at least one playback session reacting substantially simultaneously to user manipulation of the incident video data stream.

20. The method of claim 19 wherein the user manipulation includes input to play, reverse, pause, stop, step reverse, step forward, or time jump the incident video data stream.

21. The method of claim 9 further comprising receiving a single exported video data stream, the single exported video data stream including the incident video data stream and the at least one playback session marked therein.

22. The method of claim 9 wherein the displaying and playing is executed with a video or media player or with at least one of a personal computer, CCTV workstation, thin client, thick client, personal digital assistant, smart phone, or handheld device, and wherein any of the personal computer, CCTV work station, thin client, thick client, personal digital assistant, smart phone, or handheld device includes internet, cloud, or web-based hardware.

23. A method comprising:
loading an incident video data stream;
displaying an image from an incident video data stream in a primary video panel on a viewing screen;
displaying an image from at least one playback session of the incident video data stream in at least one secondary video panel on the viewing screen; and
based on user input, playing the incident data stream in the primary video panel and playing the at least one playback session in the at least one secondary video panel,
wherein the at least one playback session corresponds to at least one marked key moment in the incident video data stream, and
wherein the at least one playback session is played in the at least one secondary video panel at a time corresponding to when the at least one marked key moment in the incident video data stream is being playing in the primary video panel.

24. The method of claim 23 wherein the displaying and playing is executed with a video or media player or with at least one of a personal computer, CCTV workstation, thin client, thick client, personal digital assistant, smart phone, or handheld device, and wherein any of the personal computer, CCTV work station, thin client, thick client, personal digital assistant, smart phone, or handheld device includes internet, cloud, or web-based hardware.

25. A system comprising:
executable control software stored on a non-transitory computer readable medium; and
at least one programmable processor for:
displaying and playing an incident video data stream in a primary video panel on a viewing screen; and
displaying and playing at least one playback session in at least one secondary video panel on the viewing screen,
wherein the at least one playback session corresponds to at least one marked key moment in the incident video data stream, and
wherein the at least one playback session is played in the at least one secondary video panel at a time corresponding to when the at least one marked key moment in the incident video data stream is being playing in the primary video panel.
